(19) United States
(12) Patent Application Publication
(10) Pub. No.: US 2024/0279973 A1
(43) Pub. Date: Aug. 22, 2024

(54) OVERHEAD GARAGE DOOR OPENING SYSTEM

(71) Applicant: Michael Lambright, Middlebury, IN (US)

(72) Inventor: Michael Lambright, Middlebury, IN (US)

(21) Appl. No.: 18/171,356

(22) Filed: Feb. 19, 2023

(51) Int. Cl. E05D 15/16; E05D 15/24

(52) U.S. Cl. CPC E05D 15/165; E05D 15/246; E05D 2015/225; E05Y 2900/106

(57) ABSTRACT

Overhead door opening system that includes one or more torsion bars that twist when the overhead doors are moved from an open to a closed position manually or by an automatic opener having a motor so as to store potential energy in the torsion bars. Potential energy stored up in the torsion bars is released when the overhead doors are raised manually or by the automatic opener so that the released energy assists in lifting the overhead doors. The overhead door opening systems of the present invention do not require torsion springs that can fail over time.

### BACKGROUND

The present invention relates generally to overhead door opening systems and more particularly relates to overhead door opening systems that include torsion bars that store up potential energy when an overhead door is closed and release stored-up potential energy when an overhead door is opened to assist in lifting the overhead door.

Overhead doors such as garage doors may weigh several hundred pounds and may be difficult to lift manually. Thus, most overhead doors have springs to assist with lifting the door. The springs are generally of one of two types: torsion springs and extension springs.

Torsion springs generally extend along a torsion rod above an overhead door. One end of a torsion spring is typically fastened to a stationary plate. The other end is then wound axially around the torsion rod a set number of rotations and secured to the torsion rod. A cable extends from a drum on one end of the torsion rod to a bracket secured to the overhead door. As the door opens, the torsion spring unwinds, turning the drum, and winding the cable onto the drum, thereby assisting in lifting the weight of the door. Similarly, as the door closes, the torsion spring re-winds, thereby assisting in controlling the descent of the overhead door.

Extension springs generally extend from a ceiling-mounted bracket to a system of pulleys and cables. A cable extends from a pulley to a bracket secured to the overhead door. As the overhead door opens, the extension spring compresses, assisting in lifting the weight of the door. Similarly, as the door closes, the spring extends, assisting in controlling the descent of the overhead door.

Both extension springs and torsion springs can be expected to last several years or even decades without breaking. When a spring does break, it is unlikely that an overhead door opener will be able to lift the weight of the door. Since the springs break so seldom, when one does break, a user may not know why the automatic door opener no longer opens the overhead door. The user may suspect that the problem lies within the automatic door opener and may attempt to repair or replace it. More importantly, if a spring breaks when an overhead door is in an open position and a user tries to close the door, the door may fall, and may crush whatever lies in its path. This can cause injury, damage, or death.

The present invention provides overhead door opening systems that do not incorporate torsion springs and do not require extension springs both of which can fail over time.

The overhead door opening systems of the present invention include torsion bars that store up potential energy when an overhead door is closed and release stored-up potential energy when an overhead door is opened to assist in lifting the overhead door.

### BRIEF SUMMARY

According to various features, characteristics and embodiments of the present invention which will become apparent as the description thereof proceeds, the present invention provides an overhead door opening system that comprises: an overhead door; at least one torsion bar, each of which has a first end held in a fixed location relative to the overhead door and a second end that is coupled to a pulley via a gearbox; and a cable coupled between each pulley and a bottom portion of the overhead door,
whereby when the overhead door is lowered from an open position to a closed position the at least one torsion bar is twisted and potential energy is stored in the at least one torsion bar.

The lifting and closing of the overhead door can be accomplished manually or in alternative embodiments an automatic door opener having a motor can be used to raise and lower the overhead door.

Potential energy stored in the at least one torsion bar is released when the overhead door is moved from the closed position to the open position.

The gearboxes transfer rotational motion between each of the at least one torsion bars and each pulley so that each of the at least one torsion bars is twisted as the pulleys rotate in one direction and each of the at least on torsion bar untwist as the pulleys rotate in an opposite direction. The gearboxes cause the second end of each of the at least one torsion bars to twist and untwist less than an amount of rotations of each pulley as the overhead door opens and closes.

A torsion pre-adjusting mechanism is provided at the first end of each of the at least one torsion bars.

In some embodiments two torsion bars are used.

The overhead door opening system can include a trolley that moves along a track for opening and closing the overhead door or a trolley that moves along a screw drive for opening and closing the overhead door.

The overhead doors can comprises garage doors having single panels or a plurality of hinged door panels.

### BRIEF DESCRIPTION OF THE DRAWINGS

The present invention will be described with reference to the attached drawings which are given as non-limiting examples only, in which:

FIG. 1 is a typical torsion spring assisted overhead garage door opening system.

FIG. 2 is a schematic diagram of an overhead garage door opening system according to the present invention.

FIG. 3 is an exploded view of a torsion pre-set adjusting mechanism according to one embodiment of the present invention.

### DETAILED DESCRIPTION OF THE DRAWINGS AND THE PRESENTLY PREFERRED EMBODIMENTS

The present invention provides overhead door opening systems that include torsion bars that store up potential energy when an overhead door is closed and release stored-up potential energy when an overhead door is opened to assist in lifting the overhead door. The overhead door can be raised and lowered manually or in alternative embodiments and automatic door opener having a motor can be used to raise and lower the overhead door.

The present invention's use of torsion bars can avoid the use of torsion springs and extension springs that can fail over time.

The overhead door opening systems of the present invention can use one or two torsion bars each of which has one end fixed to a non-movable structure near an overhead door such as a header and a second end that can rotate and twist the torsion bars. The second end of the torsion bars is coupled to a gearbox which is coupled to a rotatable pulley. A cable is coupled between the pulleys and a lower portion of the overhead door so that the pulleys rotate about a shaft that rotates gears within the gearboxes. The gearboxes in turn rotate the second ends of the torsion bars in such a manner that while the pulleys rotate a number of times, the second ends of the torsion bars do not rotate, but only twist to build up potential energy in the torsion bars.

The potential energy is built up in the torsion bars as the overhead door is closed and is released, assisting in lifting the overhead doors, when the overheard door is raised by an automatic door opening operating the overhead door or manually lifted/closed by an individual.

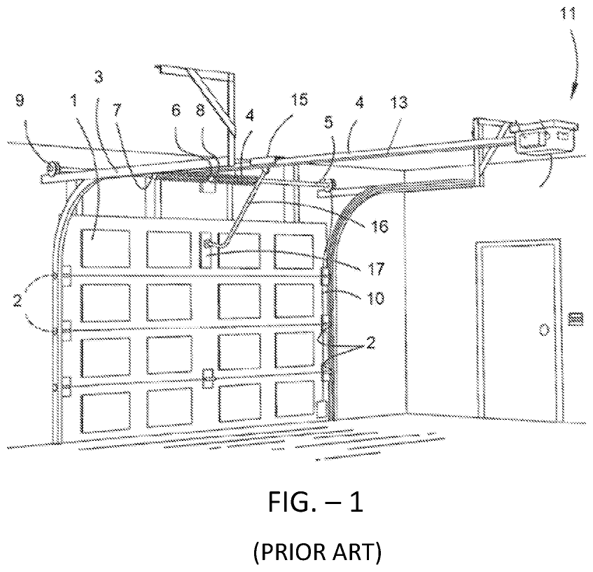

FIG. 1 is a typical torsion spring assisted overhead garage door opening system.

As shown in FIG. 1 the overhead garage door 1 has a plurality of rollers 2 disposed along each side of overhead garage door 1 which plurality of rollers 2 move along tracks 3 as overhead garage door 1 opens and closes. Tracks 3 include a generally vertical portion that rollers 2 occupy when overhead garage door 1 is closed, a generally horizontal portion that the rollers 2 occupy when the overhead garage door 1 is open, and a curved portion extending therebetween. The overhead garage door 1 has at least one torsion spring 4 to assist in opening and closing the overhead garage door 1.

In overhead garage doors which employ torsion springs to help lift and to control the descent of overhead doors, the overhead garage door 1 typically includes at least one torsion spring 4 mounted to a torsion rod 5. Torsion rod 5 is disposed above and extend generally parallel to the top edge of overhead garage door 1. The at least one torsion spring 4 has a stationary cone 6 at a first end of torsion rod 5 and a winding cone 7 at a second end. Stationary cone 6 may be secured to a center bearing plate 8. Winding cone 7 is secured to torsion rod 5 to allow torsion rod 5 to rotate as overhead garage door 1 opens and closes. Torsion spring 4 is wound a set number of rotations around the torsion rod 5 prior to winding cone 7 being secured to torsion rod 5 to present the spring force on the torsion rod 5.

As the torsion rod 5 rotates as overhead door 1 opens or closes, a drum 9 at each end of torsion rod 5 rotates. A cable 10 having a first end secured to drum 9 and a second end secured to a bottom portion of the overhead garage door 1 is wound on drum 9 when overhead garage door 1 opens helping to lift the overhead garage door 1 and unwinds from drum 9 when overhead door closes, controlling the descent of the overhead garage door 1 due to forces built up and released from the at least one torsion spring 4 that are applied to the torsion rod 5.

An automatic door opener 11 shown in FIG. 1 opens and closes the overhead garage door 1 automatically. Automatic door opener 11 includes a motor in a housing 12. A chain or belt 13 extends from housing 12 along a track 13 and connects to a trolley 15. In some overhead garage door opening systems a screw drive (not shown) is used in place of the track and chain or belt shown in FIG. 1. Track 14 ends near the wall in which the overhead garage door 1 is located. Trolley 15 is secured to the chain or belt 13 and is configured to move along track 14. When the overhead garage door 1 is in an open position, trolley 15 will be disposed near the end of track 14 near automatic door opener housing 12, and when the overhead garage door 1 is in a closed position, trolley 15 will be disposed at the end of track 14 near the wall on which the overhead garage door 1 is located. As shown in FIG. 1 a first end of a door arm 16 is removably secured to trolley 15 and a second end of door arm 16 is attached to bracket 17 that is attached to an upper portion of the overhead garage door 1.

The automatic door opener 11 includes a controller that can receive a user input that causes the automatic door opener to open and close the overhead garage door 1. User input to the controller of the automatic door opener can come from a wired or wireless wall-mounted switch or panel or a wireless remote device such as the type of a remote opener switch that can be carried in a car and clipped.

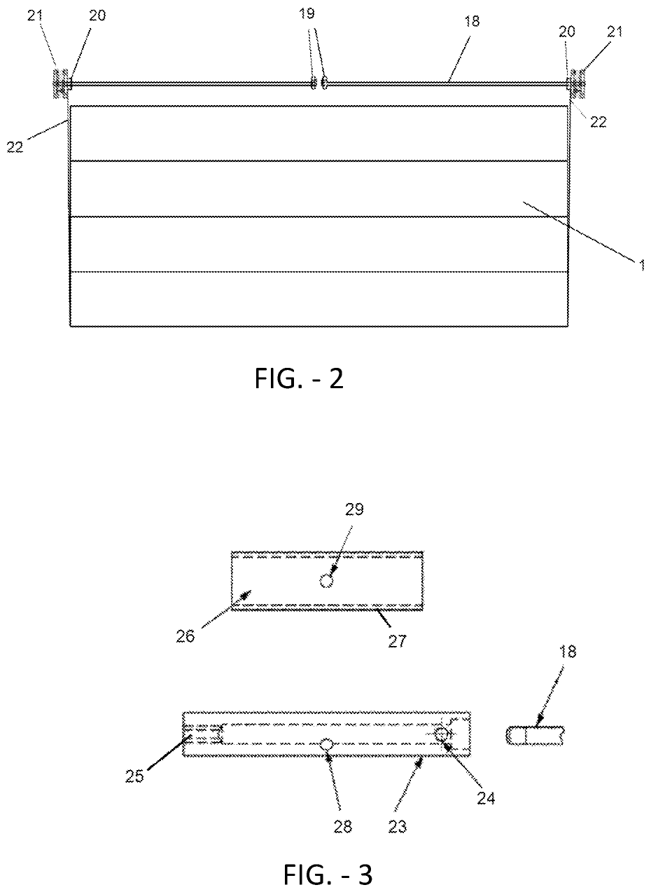

FIG. 2 is a schematic diagram of an overhead garage door opening system according to the present invention.

The overhead garage door system of the present invention uses one or two torsion bars in place of the torsion spring(s) of a conventional torsion spring assisted overhead garage door opening system exemplified in FIG. 1.

The torsion bar(s) used in the present invention are configured and installed to twist and store potential energy which stored energy is used to assist in lifting and holding/supporting the weight of an overhead door in an opened or intermediate position. Here again it is noted that according to the present invention the overhead doors can be raised and lowered manually or an automatic door opening having a motor can be used to raise and lower the overhead doors.

As illustrated in FIG. 2 torsion bars 18 are fixed in a location above an overhead garage door opening similar to the torsion rod and torsion springs shown in FIG. 1.

A first end of each torsion bar 18 is attached to fixed structure of the garage or building having the overhead garage door provided therein, such as the header over the door opening. The first ends of the torsion bars 18 are secured in an adjustable, non-rotational manner to the fixed structure by torsion force pre-adjusting members 19. The second ends of the torsion bars 18 are coupled to pulleys 20 by gearboxes 21 as discussed below. Cables 22 connected to bottom portions of the overhead garage door 1 are coupled to pulleys 20 so that they can be wound on and unwound from the pulleys 20.

FIG. 3 is an exploded view of a torsion pre-set adjusting mechanism according to one embodiment of the present invention.

The mechanism in FIG. 3 includes a tubular torsion force adjusting member 23 that receives the first end of a torsion bar 18 in one end thereof and secures torsion bar 18 by a set screw (not shown) that is received in bore 24. The opposite end of force adjusting member 23 includes a hex-shaped bore 25 that is configured to receive an allen wrench (or other tool) therein to rotate force adjusting member 23 within bore 29 of tube 27 that is attached to a fixed structure. Near the center of force adjusting member 23 are a plurality of bores 28 (one shown) that can selectively be aligned with bore 29 in the tube 27 to be fixed by a pin or other mechanical fastener.

In use one adjusts or pre-sets tension in the tension bar 18 by rotating force adjusting member 23 (using an allen wrench or other too in the bottom) until a desired bore 28 is aligned with bore 29 and then inserts a pin or other mechanical fastener into the aligned bores.

In further embodiments of the present invention other known mechanisms used to pre-set or adjust the torsion in the torsion bars 18 could be used such as the adjuster arms/flanges/levers and adjuster bolts/screws found in U.S. Patent Application Publication Nos. 2005/0046138 to Dagg et al. and 2004/0212168 to Verbowski, and U.S. Pat. No. 4,185,697 to Berg, the disclosures of which are hereby expressly incorporated by reference.

The second ends of the torsion bars 18 are coupled to gearboxes 21 which gearboxes 21 are also coupled to rotatable pulleys 20. The gearboxes allow the pulleys 20 to rotate when overhead garage door is lowered and raised. The pulleys 20 are coupled to the gearboxes 21 on shafts. The gearboxes 21 transfer the rotational movement of the pulleys 20 to the twist the torsion bars 18 about their second ends and store potential energy in the torsion bars 18 when the overhead garage door is lowered, which stored energy assists in lifting and holding/supporting the weight of an overhead garage door 1 in an opened or intermediate position.

The pulleys 20 can rotate a number of times. In tests conducted with an overhead garage door opening system of the present invention pulleys 20 were used that rotated through 6.5 rotations as an overhead garage door opened and closed. The torsion bars 18 used in the overhead garage door 1 opening system rotator/twist only about 100-140 degrees. Accordingly, it can be understood that the gearboxes are configured to transfer rotational movement between the torsion bars 18 and pulleys 20 as the overhead garage door 1 is raised and lowered while proportioning the amount of rotation between the pulleys 20 and torsion bars 18. For example in test conducted with an overhead garage door opening system of the present invention the pulleys 20 rotated through 6.5 rotations while the torsion bars 18 rotated only 120 degrees. One can easily determine a suitable gear ratio for a gearbox 21 based on the height of a door to be opened and the height at which the torsion bars 18 and pulleys 20 will be mounted so that the torsion bars 18 are limited in the amount they will be rotated/twisted.

The mechanism to raise and lower an overhead garage door according to the present invention can include the tracks, door panel rollers, automatic door opener, motor, chain or belt, a track, trolley (or screw drive), door arm, etc. that are discussed above in reference a typical torsion spring assisted overhead garage door opening system.

The use of torsion bars in an overhead door opening system according to the present invention simplifies the overall system as compared to the use of torsion rods and torsion springs and avoids the known hazards of torsion springs breaking and failing to support the weight of overhead doors that can weight hundreds of pounds.

While the present invention has been described in reference to overhead garage doors it is to be understood that the features of the present invention can be used in conjunction with any type of overhead doors, both residential and commercial. The overhead door opening system of the present invention can be used in conjunction with one-piece over head doors or with overhead doors that comprise a plurality of door panels that are coupled together by hinges. Such overhead garage doors are well known.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. An overhead door opening system that comprises:
an overhead door;
at least one torsion bar, each of which has a first end held in a fixed location relative to the overhead door and a second end that is coupled to a pulley; and
a cable coupled between each pulley and a bottom portion of the overhead door,
whereby when the overhead door is lowered from an open position to a closed position the at least one torsion bar is twisted and potential energy is stored in the at least one torsion bar.

2. An overhead door opening system according to claim 1, wherein the potential energy stored in the at least one torsion bar is released when the overhead door is moved from the closed position to the open position.

3. An overhead door opening system according to claim 1, further comprising a gearbox that couples the second end of each of the at least one torsion bar and each pulley.

4. An overhead door opening system according to claim 3, wherein the gearbox causes the second end of each of the at least one torsion bars to twist less than an amount of rotations of each pulley as the overhead door opens and closes.

5. An overhead door opening system according to claim 1, wherein a torsion pre-adjusting mechanism is provided at the first end of each of the at least one torsion bar.

6. An overhead door opening system according to claim 1, wherein the at least one torsion bar comprises two torsion bars.

7. An overhead door opening system according to claim 1, further comprising an automatic door opener that includes a motor that drives a trolley along a track for opening and closing the overhead door.

8. An overhead door opening system according to claim 1, further comprising an automatic door opener that includes a motor that drives a trolley along a screw drive for opening and closing the overhead door.

9. An overhead door opening system according to claim 1, wherein the overhead door comprises a garage door.

10. An overhead door opening system according to claim 1, wherein the garage door comprises a plurality of hinged door panels.

11. In an overhead door opening system including an automatic door opener having a motor for raising and lowering an overhead door, the improvement comprising:
at least one torsion bar, each of which has a first end held in a fixed location relative to the overhead door and a second end that is coupled to a pulley; and
a cable coupled between each pulley and a bottom portion of the overhead door,
whereby when the overhead door is lowered from an open position to a closed position the at least one torsion bar is twisted and potential energy is stored in the at least one torsion bar.

12. An overhead door opening system according to claim 11, wherein the potential energy stored in the at least one torsion bar is released when the overhead door is moved from the closed position to the open position.

13. An overhead door opening system according to claim 11, further comprising a gearbox that couples the second end of each of the at least one torsion bar and each pulley.

14. An overhead door opening system according to claim 13, wherein the gearbox causes the second end of each of the at least one torsion bars to twist less than an amount of rotations of each pulley as the overhead door opens and closes.

15. An overhead door opening system according to claim 11, wherein a torsion pre-adjusting mechanism is provided at the first end of each of the at least one torsion bar.

16. An overhead door opening system according to claim 11, wherein the at least one torsion bar comprises two torsion bars.

17. An overhead door opening system according to claim 11, further comprising an automatic door opener having a motor that drives a trolley along a track for opening and closing the overhead door.

18. An overhead door opening system according to claim 11, further comprising an automatic door opener that includes a motor that drives a trolley along a screw drive for opening and closing the overhead door.

19. An overhead door opening system according to claim 11, wherein the overhead door comprises a garage door.

20. An overhead door opening system according to claim 11, wherein the garage door comprises a plurality of hinged door panels.
